(19) United States
(12) Patent Application Publication
(10) Pub. No.: US 2025/0314846 A1
(43) Pub. Date: Oct. 9, 2025

(54) FIBER OPTIC CABLE ASSEMBLY WITH IN-LINE DISTRIBUTION ASSEMBLIES HAVING OPTICAL SPLITTERS AND METHOD OF MAKING AND USING SAME

(71) Applicant: CORNING RESEARCH & DEVELOPMENT CORPORATION, Corning, NY (US)

(72) Inventors: Terry Lee Cooke, Hickory, NC (US); Lars Kristian Nielsen, Denver, NC (US)

(21) Appl. No.: 19/244,150

(22) Filed: Jun. 20, 2025

Related U.S. Application Data
(63) Continuation of application No. PCT/US24/18587, filed on Mar. 6, 2024.
(60) Provisional application No. 63/451,663, filed on Mar. 13, 2023.

(51) Int. Cl. G02B 6/44

(52) U.S. Cl. CPC G02B 6/44528

(57) ABSTRACT

A fiber optic cable assembly includes a fiber optic cable carrying a plurality of optical fibers and a plurality of distribution assemblies at spaced locations along a length of the fiber optic cable. At least one optical fiber carried by the fiber optic cable is terminated at each of the plurality of distribution assemblies to define a branch cable. Each of the plurality of distribution assemblies includes a distribution housing and splitter module selectively connectable to the distribution housing. The splitter module includes an optical splitter configured to split an incoming optical signal from the branch cable into an outgoing optical signal in a respect one of a plurality of outgoing optical fibers in the splitter module. The distribution assemblies are in-line with the cable and have a low-profile for ease of installation. A method of using and making such a fiber optic cable assembly is also disclosed.

### PRIORITY APPLICATION

This application is a continuation of International Application No. PCT/US2024/018587, filed on Mar. 6, 2024, which claims the benefit of priority to U.S. Application No. 63/451,663, filed on Mar. 13, 2023, both applications being incorporated herein by reference.

### TECHNICAL FIELD

This disclosure relates generally to fiber optic cables, and more particularly to a fiber optic cable assembly including a plurality of in-line, low-profile optical distribution assemblies having optical splitters arranged along a length of the cable to distribute optical signals to multiple destinations.

### BACKGROUND

The large amount of data and other information transmitted over the internet has led businesses and other organizations to develop large scale data centers for organizing, processing, storing and/or disseminating large amounts of data. Data centers contain a wide range of network equipment including, for example, servers, networking switches, routers, storage subsystems, etc. Data centers further include a large amount of cabling and racks to organize and interconnect the network equipment in the data center. Modern data centers may include multi-building campuses having, for example, one primary or main building and a number of auxiliary buildings in close proximity to the main building. All the buildings on the campus are interconnected by a local fiber optic network.

Data center design and cabling-infrastructure architecture are increasingly large and complex. To manage the interconnectivity of a data center, the network equipment within the buildings on the data center campus is often arranged in structured data halls having a large number of spaced-apart rows. Each of the rows is, in turn, configured to receive a number of racks or cabinets (e.g., twenty racks or cabinets) which hold the network equipment. In some data center architectures, each of the rows includes a main patch panel (referred to as an intermediate distribution frame), which may be at a front or head end of the row. Distribution cables with relatively large number of optical fibers (high fiber counts) are routed from a building distribution frame (referred to as a main distribution frame) to the intermediate distribution frames for the different rows of equipment racks. At the intermediate distribution frames, a large number of distribution fiber optic cables with lower fiber counts are connected to the optical fibers of the associated high fiber count distribution cable(s) and routed along the row to connect to the network equipment held in the various racks in the row. To organize the large number of in-row distribution fiber optic cables, each row typically includes a cable tray or basket disposed above the row for supporting the distribution fiber optic cables as they extend along the row. The network equipment in the racks is optically connected to the distribution fiber optic cables by technicians during the construction of the data center.

While current data center design and cabling-infrastructure architecture are satisfactory for the current needs of the industry, the labor, installation time, and costs to achieve the interconnectivity of the data center can be high. For these reasons, manufacturers continually strive to improve the interconnectivity in the data center. For example, one approach to improve optical infrastructure installation efficiency is to pre-engineer infrastructure components. Such components, such as fiber optic cables, may be pre-terminated in a factory with connectors installed, tested, and packaged for fast, easy, and safe installation at a data center. In this way, an installer would unpack the components, pull or route the pre-connectorized fiber optic cable, snap in connectors (e.g., such as at the row patch panel), and install jumpers to end equipment. This saves a significant amount of time, effort, and costs compared to on-site connectorization and assembly of cables.

By way of example, various pre-engineered cables for row interconnectivity at data centers are disclosed in PCT Patent Publication No. WO2020214762A1 (“the '762 publication”), the disclosure of which is incorporated herein by reference in its entirety. As disclosed in the '762 publication, a pre-engineered cable may be a high-fiber count cable having a pre-connectorized distribution end for connection to the main patch panel (sometimes referred to as an intermediate distribution frame) for a row (e.g., at a head end of the row). The fiber optic cable then has a plurality of distributed drop cables (also referred to as “tap cables”) that extend from the main cable at drop points (“tap points”) along the length of the cable. The drop points along the fiber optic cable are designed to correspond to the rack spacing and configuration in the row. The ends of the drop cables are also pre-connectorized for easy and quick connection to the network equipment in the racks positioned in the row. In this way, the pre-engineered fiber optic cable may be removed from its packaging, routed along the cable tray so that the drop points correspond in location to the racks in the row, connected at the distribution end of the cable to the intermediate distribution frame, and connected at the pre-connectorized ends of the drop cables to the respective network equipment in the racks. With such a pre-engineered fiber optic cable, it is estimated that installation time for row interconnectivity may be reduced from several hours to several minutes.

Furthermore, conventional pre-engineered fiber optic cables with in-line distribution assemblies are typically constructed with a predetermined amount of distributed drop cables at each tap point along the length of the cable, which limits the flexibility or adaptability of the fiber optic network for different applications. For example, if a particular tap point requires a different optical split count than what is available, the network operator may need to replace the entire pre-engineered fiber optic cable or use additional splitters, which can be expensive and time-consuming.

Therefore, there is a need for pre-engineered fiber optic cables that can reduce labor, installation time, and costs in the industry. In particular, there is a need for a fiber optic cable assembly that provides in-line distribution assemblies at tap points which allow for interchangeable optical splitters to vary the optical split count at each tap point. As the demand for even faster and more cost-efficient installation continues to increase, the need for such pre-engineered fiber optic cables becomes even more pressing.

### SUMMARY

In one aspect of the disclosure, a fiber optic cable assembly having a plurality of distribution assemblies is disclosed. The fiber optic cable assembly includes a fiber optic cable having a distribution end, a terminal end, and carries a plurality of optical fibers, and a plurality of distribution assemblies attached to the fiber optic cable along a length of the fiber optic cable. Each of the of the plurality of distribution assemblies includes a distribution housing receiving the fiber optic cable, and an optical splitter disposed in the distribution housing. Each of the plurality of distribution housings includes a subset of the plurality of optical fibers carried by the fiber optic cable branched off from the fiber optic cable and terminated by at least one branch connector, and the optical splitter is configured to split an incoming optical signal from at least one optical fiber belonging to the subset of optical fibers into a plurality of outgoing optical signals carried by a plurality of outgoing optical fibers.

In one embodiment, each of the plurality of distribution assemblies may further include a splitter module having a first end, a second end, and an interior cavity. The splitter module may be selectively connected to the distribution housing. The splitter module includes the optical splitter in the interior cavity, and at least one branch connector is selectively connectable to the first end of the splitter module. In another embodiment of the disclosed fiber optic cable assembly, the distribution housing of each of the plurality of distribution assemblies may include a module bay configured to receive the splitter module. The splitter module may be movable between a first position substantially located within the module bay and a second position substantially located external of the module bay. For example, the splitter module may be slidable between the first position and second position. In another embodiment of the fiber optic cable assembly, the splitter module and/or the distribution housing may include a latch for connecting the splitter module to the distribution housing when in the first position, for example.

In one embodiment of the fiber optic cable assembly, the first end of the splitter module may include a first adapter interface having at last one exterior connector port for receiving the branch connector. In another embodiment of the fiber optic cable assembly, the fiber optic assembly may include a plurality of tap cables each having a proximal end and a distal end. For each of the plurality of tap cables, the proximal end may be connected to or is configured to be connected to a respective one of the plurality of outgoing optical fibers of the optical splitter, and the distal end may be terminated by a distal tap connector. In yet another embodiment, the proximal end of each of the plurality of tap cables may be terminated by a proximal tap connector. In another embodiment of the fiber optic cable assembly, the second end of the splitter module may include a second adapter interface having a plurality of exterior connector ports that is connected to or configured to be connected to a proximal tap connector of a respective one of the plurality of tap cables.

In one embodiment of the fiber optic cable assembly, the at least one branch connector may be a single fiber connector, and preferably a single fiber LC connector. In another embodiment of the fiber optic cable assembly, the distribution end of the fiber optic cable may include at least one multi-fiber connector, preferably one multi-fiber connector, such as a MMC connector.

In another aspect of the disclosure, a method of handling a fiber optic cable assembly is disclosed. The method includes providing a fiber optic cable having a distribution end, a terminal end, and carrying a plurality of optical fibers, and a plurality of distribution assemblies attached to the fiber optic cable along a length of the fiber optic cable. Each of the plurality of distribution assemblies includes a distribution housing receiving the fiber optic cable, and an optical splitter disposed in the distribution housing. For each of the plurality of distribution housings, a subset of the plurality of optical fibers carried by the fiber optic cable is branched off from the fiber optic cable and terminated by at least one branch connector, and the optical splitter is configured to split an incoming optical signal from at least one optical fiber belonging to the subset of optical fibers into a plurality of outgoing optical signals carried by a plurality of outgoing optical fibers. The method further includes, for at least one of the plurality of distribution assemblies, removing the optical splitter from the distribution housing, the optical splitter having a first split ratio. The method further includes disconnecting the at least one branch connector from the optical splitter, providing another optical splitter having a second split ratio different from the first split ratio, connecting the at least one branch connector to the another optical splitter, and attaching the another optical splitter to the distribution housing.

In one embodiment, an optical splitter may be provided in a first splitter module and another optical splitter may be provided in a second splitter module may be provided. According to the method, removing the optical splitter from the distribution housing may include removing the first splitter module from the distribution housing and attaching another optical splitter to the distribution housing may include attaching the second splitter module to the distribution housing.

In another embodiment of the disclosed method, the method may further include disconnecting the at least one branch connector from the optical splitter, which may include disconnecting the at least one branch connector from the first splitter module, and connecting the at least one branch connector to another optical splitter, which may include connecting the at least one branch connector to the second splitter module.

In another embodiment of the disclosed method, the distribution housing may include a module bay for receiving a splitter module, and removing the first splitter module from the distribution housing includes slidably removing the first splitter module from the module bay. Moreover, in this embodiment, attaching the second splitter module to the distribution housing may include slidably inserting the second splitter module into the module bay. In yet another embodiment of the disclosed method, removing the first splitter module from the distribution housing includes releasing a latch to allow the first splitter module to be removed from the distribution housing, and attaching another optical splitter to the distribution housing includes engaging a latch to allow the second splitter module to be retained in the distribution housing.

In another embodiment of the disclosed method, the method may further include disconnecting a first set of the plurality of tap cables from the first optical splitter and reconnecting a second set of the plurality of tap cables to the second optical splitter. The number of tap cables in the first set of the plurality of tap cables may be different from the number of tap cables in the second set of the plurality of tap cables.

In another aspect of the disclosure, a method of making a fiber optic cable assembly is disclosed. The method includes providing a fiber optic cable having a distribution end, a terminal end, and carrying a plurality of optical fibers, and selecting a plurality of distribution locations along a length of the fiber optic cable. With respect to each of the plurality of distribution locations, the method may further include branching off a subset of the plurality of optical fibers carried by the fiber optic cable, terminating the subset of the plurality of optical fibers with at least one branch connector, disposing a distribution housing about the fiber optic cable, and locating an optical splitter in the distribution housing. The optical splitter is configured to split an incoming optical signal from at least one optical fiber belonging to the subset of optical fibers into a plurality of outgoing optical signals carried by a plurality of outgoing optical fibers, and connecting the at least one branch cable to the optical splitter.

In an embodiment of the disclosed method, the optical splitter may be provided in a splitter module, and locating the optical splitter in the distribution housing may include locating the splitter module in the distribution housing. In one embodiment of the disclosed method, the splitter module may be selected from a plurality of splitter modules where each of the plurality of splitter modules may have a different optical split ratio.

In another embodiment of the disclosed method, the distribution housing may include a module bay configured to receive the splitter module and locating an optical splitter in the distribution housing may include sliding the splitter module into the module bay in the distribution housing. In yet another embodiment of the disclosed method, the method may further include engaging a releasable latch to retain the splitter module in the distribution housing.

In one embodiment of the disclosed method, the method may further include connecting the plurality of outgoing optical fibers of the optical splitter to a plurality of tap cables. Each of the plurality of tap cables may be terminated at its distal end by a distal end tap connector. In yet another embodiment of the disclosed method, the optical splitter may include an adapter interface defining a plurality of exterior connector ports, and each of the plurality of tap cables may include at its proximal end a proximal end tap connector. In that regard, connecting the plurality of outgoing optical fibers to the plurality of tap cables may include, for each of the plurality of tap cables, inserting the proximal end tap connector into a respective one of the plurality of exterior connector ports of the adapter interface.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic illustration of a data center campus according to an exemplary embodiment of the disclosure.

FIGS. 2 and 2A are partial perspective views of an exemplary data hall of the data center shown in FIG. 1 according to one embodiment.

FIG. 3 is a schematic view of a fiber optic distribution cable assembly in accordance with an embodiment of the disclosure.

FIG. 4 is an exemplary cross-sectional view of the fiber optic cable of the cable assembly shown in FIG. 3 according to an embodiment of the disclosure.

FIG. 5 is a perspective view of one distribution assembly of the fiber optic distribution cable assembly of FIG. 3, illustrating a splitter module removed from a distribution housing of the distribution assembly.

FIG. 6 is a cross-sectional view of the distribution assembly of FIG. 5, illustrating the splitter module removed from the distribution housing and disconnected from a branch cable.

FIG. 7 is a view similar to FIG. 6, illustrating the splitter module removed from the distribution housing and connected to the branch cable.

FIG. 8 is a view similar to FIGS. 6 and 7, illustrating the splitter module connected to the branch cable and received within a module bay of the distribution housing.

FIG. 9 is a cross-sectional view of a distribution assembly according to another embodiment of the invention, illustrating a stop collar of the branch cable engaged with the body of the distribution housing.

### DETAILED DESCRIPTION

Various embodiments will be further clarified by examples in the description below. In general, the description relates to a fiber optic distribution cable assembly including a fiber optic cable and a plurality of distribution assemblies spaced along a length of the cable at tap points. Each distribution assembly includes a distribution housing configured to receive a corresponding splitter module. The distribution housing is configured to be in-line with the fiber optic cable, such as generally being disposed about the fiber optic cable to have a low-profile such that the distribution housings remain in close proximity to the fiber optic cable. In this way, the distribution housings avoid or limit snagging and other obstacles during installation of the distribution cable assembly. The spacing between the distribution assemblies along the length of the cable generally corresponds with the spacing between racks in a row in a data hall of a data center such that when the distribution cable assembly is installed, the distribution assemblies, and in particular the distribution housings are disposed generally above the racks in the row.

The fiber optic cable includes a number of optical fibers that are individually terminated and presented for optical connection at an associated distribution housing. These individually terminated optical fibers extend from the main fiber optic cable and may be referred to as branch cables, for example. Furthermore, each distribution housing is configured to receive a corresponding splitter module. The splitter module is removably connectable to the distribution housing and the branch cable connector to form an optical connection that splits the single incoming optical signal of the branch cable into multiple output signals associated with tap cables and network equipment in a rack that is connected to the tap cables of the splitter module. To this end, by locating optical splitters at tap points along the fiber optic distribution cable assembly, the number of optical fibers needed in the fiber optic distribution cable assembly can be reduced. Moreover, this may eliminate the need for a branch box at the end of the data center racks, for example. Additionally, different splitter modules may be used to vary the optical split count at each tap point along the fiber optic distribution cable assembly to improve the flexibility or adaptability of the fiber optic distribution cable assembly for different applications. These and other benefits of the present invention will be described in further detail below.

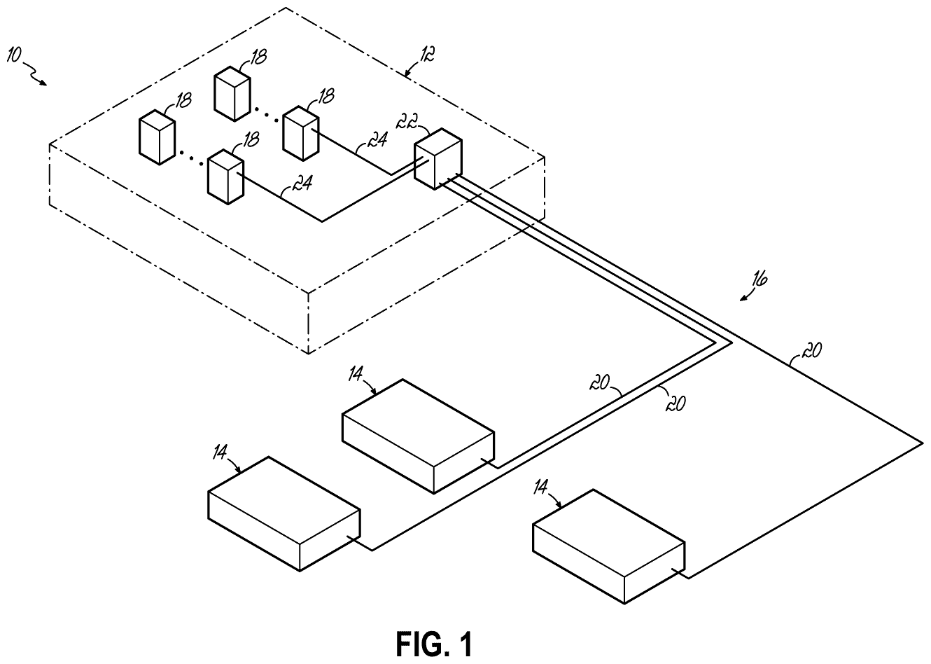

As illustrated in FIG. 1, a modern-day data center 10 may include a collection of buildings (referred to as a data center campus) having, for example, a main building 12 and one or more auxiliary buildings 14 in close proximity to the main building 12. While three auxiliary buildings 14 are shown, there may be more or less depending on the size of the campus. The data center 10 provides for a local fiber optic network 16 that interconnects the auxiliary buildings 14 with the main building 12. The local fiber optic network 16 allows network equipment 18 in the main building 12 to communicate with various network equipment (not shown) in the auxiliary buildings 14. In the exemplary embodiment shown, the local fiber optic network 16 includes trunk cables 20 extending between the main building 12 and each of the auxiliary buildings 14. Conventional trunk cables 20 generally include a high fiber-count arrangement of optical fibers for passing data and other information through the local fiber optic network 16. In the example illustrated in FIG. 1, the trunk cables 20 from the auxiliary buildings 14 are routed to one or more distribution cabinets 22 housed in the main building 12 (one shown).

Within the main building 12, a plurality of indoor fiber optic cables 24 (“indoor cables 24”) are routed between the network equipment 18 and the one or more distribution cabinets 22. The indoor cables 24 generally include a high fiber-count arrangement of optical fibers for passing data and other information from the distribution cabinets 22 to the network equipment 18. Although only the interior of the main building 12 is schematically shown in FIG. 1 and discussed above, each of the auxiliary buildings 14 may house similar equipment for similar purposes. Thus, although not shown, each of the trunk cables 20 may be routed to one or more distribution cabinets 22 in one of the auxiliary buildings 14 in a manner similar to that described above. Furthermore, each of the auxiliary buildings 14 may include indoor cables 24 that extend between network equipment 18 and the one or more distribution cabinets 22 of the auxiliary building 14.

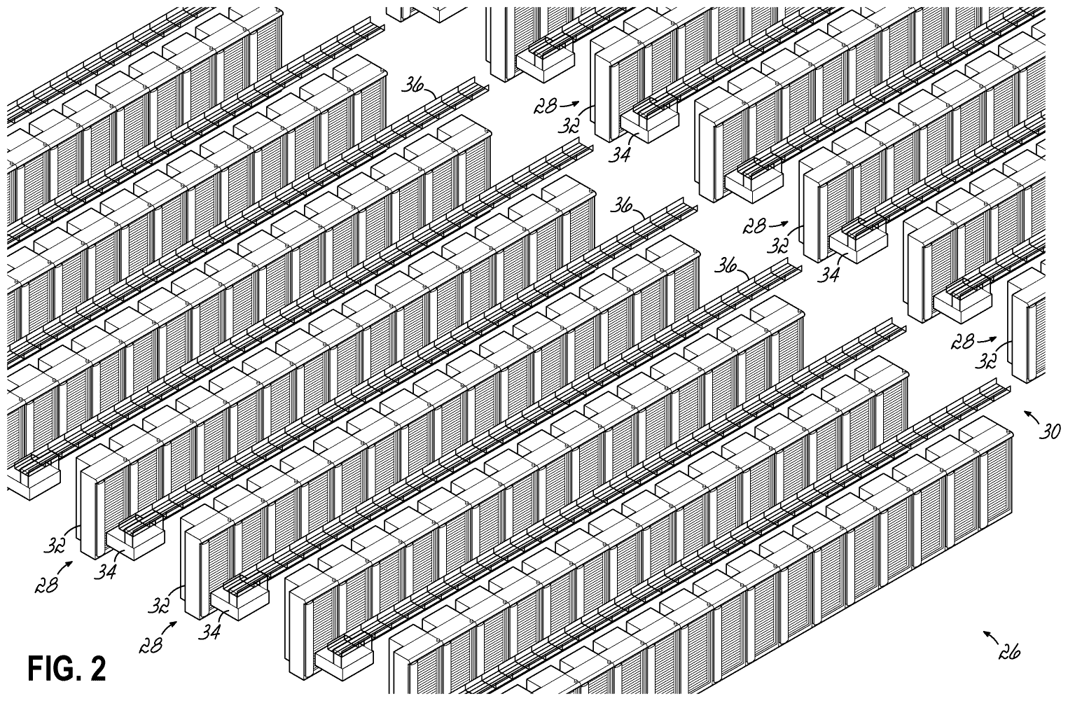

As illustrated in more detail in FIGS. 2 and 2A, the network equipment 18 in the main building 12 or an auxiliary building 14 may be arranged in one or more data halls 26 that generally include a plurality of spaced-apart rows 28 on one or both sides of an access pathway 30. The arrangement of the data halls 26 into rows 28 helps organize the large number of equipment, fiber optic cables, fiber optic connections, etc. Each of the rows 28 includes a plurality of racks or cabinets 32 (referred to hereafter as “racks 32”) generally arranged one next to the other along the row 28. Each of the racks 32 are vertically arranged frames for holding various network equipment 18 of the data center 10, as is generally known in the telecommunications industry. In one common arrangement, and as further illustrated in FIG. 2, each row 28 may include an intermediate distribution frame 34 (sometimes referred to as an intermediate distribution frame) at the front or head end of the row 28 closest to the access pathway 30. The intermediate distribution frame 34 represents a termination point of at least some of the optical fibers carried by one or more of the indoor cables 24, for example. Although the intermediate distribution frame 34 is shown as being positioned above the row 28, in other embodiments the intermediate distribution frame may be in a cabinet (not shown) at the head end of the row 28 or in the first rack 32 at the head end of the row 28. In yet other embodiments, the intermediate distribution frame 34 may be located within the associated row, such as in the middle of the row, and be above, below, or within one of the racks 32. In other embodiments, the intermediate distribution frame 34 is not needed.

As discussed above, in a conventional arrangement, at least one distribution cable is connected to the intermediate distribution frame 34 of a row 28 and routed along a cable tray 36 generally disposed above the row 28. For example, the at least one distribution cable may be located in the cable tray 36 or suspended below the cable tray by hooks, clips, or other suitable fasteners. In either case, the network equipment 18 in the racks 32 is optically connected to the at least one distribution cable to provide the interconnectivity of the network equipment 18 of the data center 10. Aspects of the present disclosure are directed to an improved fiber optic distribution cable assembly configured to be connected to the intermediate distribution frame 34 of a row 28 and routed along the cable tray 36 or other cable support of the row 28 for connection to the network equipment 18 in the racks 32 that make up the row 28.

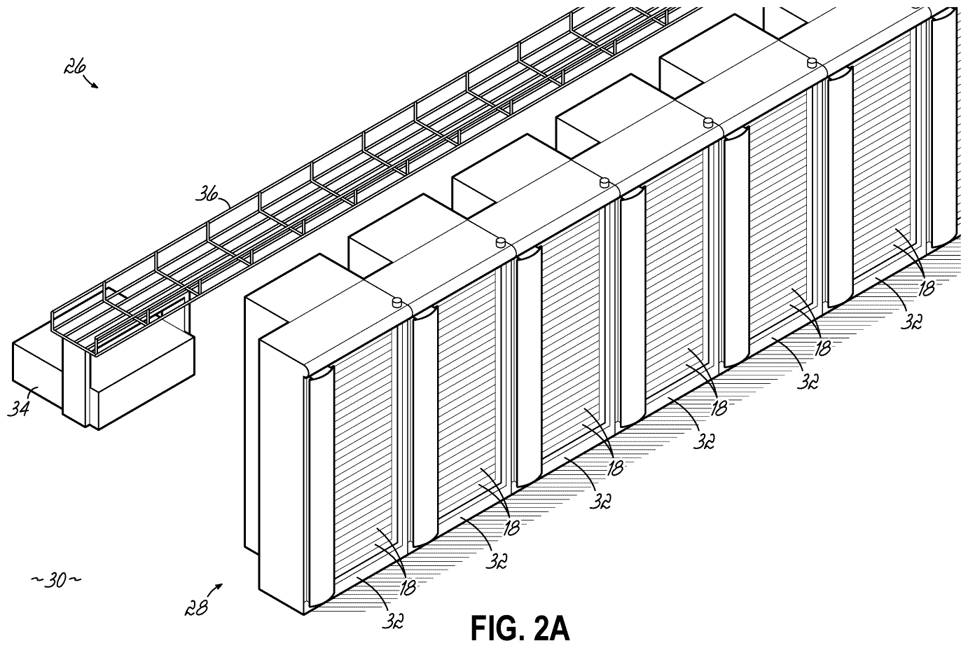

FIG. 3 illustrates an exemplary fiber optic distribution cable assembly 38 (“distribution cable assembly 38”) in accordance with an embodiment of the disclosure. Although the distribution cable assembly 38 will be discussed in more detail below in the context of a fiber optic cable assembly connected between the intermediate distribution frame 34 at the head end of a row 28 and the network equipment 18 in the racks 32 of the row 28, the distribution cable assembly 38 is not limited to such an application. Accordingly, it should be understood that the distribution cable assembly 38 may be used in other contexts of a data center, or other contexts of a fiber optic network more generally. To this end, the drawings are not intended to be limiting.

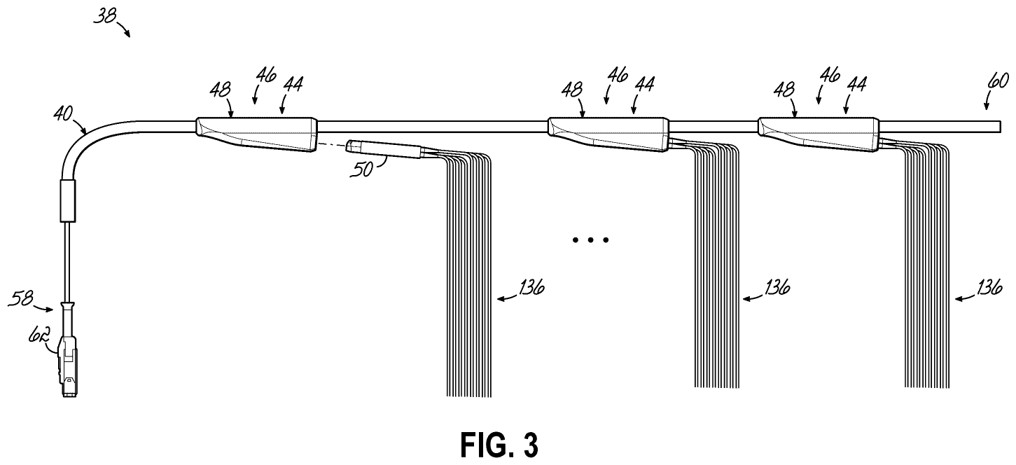

As illustrated in FIGS. 3 and 4, the distribution cable assembly 38 generally includes a fiber optic cable 40 that carries one or more optical fibers 42 for passing data and other information through the local fiber optic network 16, and more specifically between the intermediate distribution frame 34 and the network equipment 18 in a row 28. In particular, the distribution cable assembly 38 includes a plurality of distribution assemblies 44 spaced along a length of the fiber optic cable 40. The distribution assemblies 44 define tap points 46 along the fiber optic cable 40 and may correspond to each equipment rack 32 of a row 28, for example. As shown, each distribution assembly 44 includes a distribution housing 48 and a splitter module 50 configured to be removably connectable to the distribution housing 48. As will be described in further detail below, the connection between the distribution housing 48 and the splitter module 50 is an optical connection, and the splitter module 50 is configured to split a single incoming optical signal from one terminated optical fiber into multiple output signals associated with network equipment 18 in a rack 32 that is connected to the splitter module 50. To that end, the distribution housing 48 of each distribution assembly 44 defines a location where a portion of the optical signal carried by the distribution cable assembly 38 is extracted and sent to the network equipment 18 in the racks 32 of the row 28.

The number of optical fibers 42 carried by the fiber optic cable 40 and how they are arranged within the fiber optic cable 40 may vary based on the application. In the embodiment shown, the number of optical fibers 42 carried by the fiber optic cable 40 corresponds to the number of distribution assemblies 44, or tap points 46, spaced along the fiber optic cable 40. By way of example and without limitation, the distribution cable assembly 38 may include five distribution assemblies 44 spaced along the length of the fiber optic cable 40. In that regard, the fiber optic cable 40 may include five optical fibers 42 corresponding to the five distribution assemblies 44 of the distribution cable assembly 38, as shown in FIG. 4. As shown, the fiber optic cable 40 includes an outer protective sheath (“outer jacket”) 52, as is generally known in the industry, and the optical fibers 42 are arranged within the fiber optic cable 40. Each optical fiber 42 includes at least a bare glass portion 54 and an coating 56. While not shown, it is understood that each optical fibers 42 may include other components known in the art for transmitting light signals over long distances with minimal loss of signal quality, such as additional coating layer(s), and a buffer layer for example. Although the fiber optic cable 40 is shown as including five optical fibers 42, the number of optical fibers 42 may be more or less than this number in alternative embodiments. Furthermore, it should be recognized that the distribution cable assembly 38 may include more or less distribution assemblies 44, and the distribution cable assembly 38 may include more or fewer optical fibers 42 compared to the number of distribution assemblies 44, for example.

With reference to FIG. 3, the distribution cable assembly 38 includes the fiber optic cable 40 having a distribution end 58, a terminal end 60 opposite the distribution end 58, and the plurality of distribution assemblies 44 disposed along the length of the fiber optic cable 40 between the distribution end 58 and the terminal end 60. Although the terminal end 60 is spaced from a final distribution housing 48 in the embodiment shown, in alternative embodiments the terminal end 60 may be at (e.g., within) the final distribution housing 48. The distribution end 58 of the fiber optic cable 40 may include a single connector 62 that terminates the optical fibers 42 carried by the cable 40. In the embodiment shown, the connector 62 may be a MMC connector. However, the connector 62 may be any suitable connector configured to be optically connected to optical interfaces associated with the intermediate distribution frame 34 at the head end of the rows 28 in the data hall 26. To this end, any conventional, or yet to be developed, optical connector or connectorization scheme may be used in accordance with the present disclosure, including, but not limited to simplex or duplex connectors (e.g., LC connectors), multi-fiber connectors (e.g., MPO connectors), and SN-MT connectors commercially available from Senko Advanced Components, Inc. As discussed above, the connector 62 at the distribution end 58 of the fiber optic cable 40 may be pre-connectorized to avoid field assembly of the connector 62 to the cable 40.

The distribution assemblies 44 of the distribution cable assembly 38, and in particular the distribution housings 48, may be arranged at distribution points or tap points 46 along the length of the fiber optic cable 40 and may be referred to as “tap housings 48”. The tap points 46 have a distribution pattern along the fiber optic cable 40 that generally corresponds to the spacing between the racks 32 in the row 28 in which the distribution cable assembly 38 is being installed. In this way, when the distribution cable assembly 38 is installed, the distribution housings 48 are generally disposed above respective racks 32 in the row 28. In one embodiment, the tap points 46 may be uniformly spaced along the length of the fiber optic cable 40 and correspond to uniformly spaced racks 32 in the row 28. In an alternative embodiment, however, the tap points 46 may be non-uniformly spaced along the length of the fiber optic cable 40 and correspond to non-uniformly spaced racks 32 in the row 28.

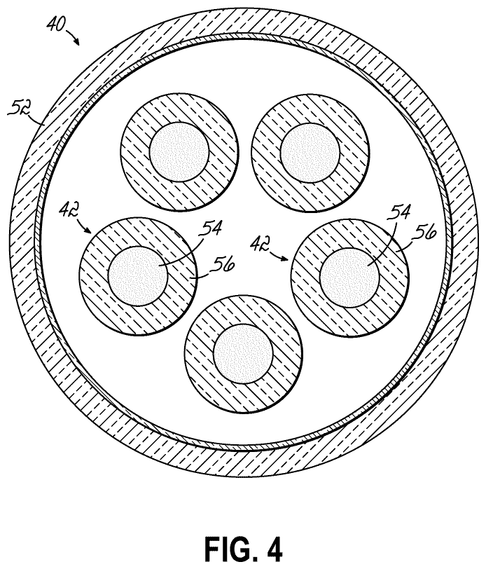

The distribution housings 48 of the distribution cable assembly 38 may represent the termination point of one optical fiber 42 carried by the fiber optic cable 40 and presents an optical interface for making optical connections to the terminated optical fiber, otherwise referred to as a branch cable 64 (e.g., FIG. 5). The distribution housings 48 may be generally disposed about the fiber optic cable 40 such that the fiber optic cable 40 passes through an interior of the distribution housings 48. In that regard, the distribution housings 48 may surround the fiber optic cable 40 and effectively represent a slightly expanded portion of the cable 40 itself. This configuration not only maintains the distribution housings 48 essentially “in-line” with the fiber optic cable 40, but also provides the distribution housings 48 with a low profile to eliminate snagging of the distribution housings 48 during installation of the distribution cable assembly 38.

Referring now to FIGS. 5-8, in an exemplary embodiment, the distribution housing 48 includes a cable receiving portion 66 for receiving the fiber optic cable 40 and splitter receiving portion 68 for receiving the splitter module 50. In particular, the distribution housing 48 includes a body 70 having sidewall 72 that extends between a front end wall 74 and a rear end wall 76 to define an outer boundary of the distribution housing 48. The body 70 of the distribution housing includes a generally rounded top 78 and a generally flat base 80. The generally flat base 80 extends at an angle, or tapers, from the front end wall 74 toward the rear end wall 76. In that regard, the front end wall 74 is generally larger compared to the rear end wall 76 to receive the splitter module 50, as will be described in further detail below. The distribution housing 48 may include a first chamfered surface 82 that extends between the front end wall 74 and the sidewall 72 and a second chamfered surface 84 that extends between the rear end wall 76 and the sidewall 72. The chamfered surfaces 82, 84 prevent snagging of the distribution housings 48 during installation of the distribution cable assembly 38. The terms “front”, “rear”, “top”, and “base” are for purposes of description and should not limit the distribution housing 48 to any particular orientation.

The cable receiving portion 66 of the distribution housing 48 is located adjacent to the top 78 of the distribution housing 48 and includes a passageway 86 that is defined by a generally tubular inner wall 88 of the body 70 of the distribution housing 48 that extends longitudinally from a first opening 90 formed in the front end wall 74 of the distribution housing 48 to an opposite second opening 92 formed in the rear end wall 76. The tubular inner wall 88 and the passageway 86 may have a larger inner diameter (ID) compared a diameter of the first opening 90 and the second opening 92, as shown. Regardless, the first and second openings 90, 92 may be axially aligned and the passageway 86 is configured to receive the fiber optic cable 40 therethrough, as shown. Stated another way, the first and second openings 90, 92 allow the fiber optic cable 40 to pass through the distribution housing 48 via the passageway 86.

The splitter receiving portion 68 of the distribution housing 48 is located adjacent to the base 80 of the distribution housing 48 and may include a module bay 94 that is configured to receive the splitter module 50. As shown, the module bay 94 extends from an opening 96 to the module bay 94 formed in the front end wall 74 of the distribution housing 48 to a base wall 98. In that regard, the opening 96 to the module bay 94 may define a first end 100 of the module bay 94 and the base wall 98 may define an opposite second end 102 of the module bay 94. The distribution housing 48 may include a latch 104 for selectively coupling the splitter module 50 to the distribution housing 48. The latch 104 may be a spring clip formed in the base 80 of the distribution housing 48 such that a locking member 106 of the latch 104 extends into the module bay 94 to engage the splitter module 50, as will be described in further detail below.

The module bay 94 may have a generally rectangular cross-sectional shape along its length. In that regard, the module bay 94 may extend a length between the first end 100, which is located at the front end wall 74 of the distribution housing 48, to the second end 102, which is located between the front end wall 74 of the distribution housing and the rear end wall 76. As shown, the second end 102 of the module bay 94 may be located closer to the rear end wall 76 compared to the front end wall 74 of the distribution housing 48. To this end, the module bay 94 may extend for a length that is equivalent to 50% or more of a length of the distribution housing 48 (i.e., a length measured between the front end wall 74 and the rear end wall 76 of the distribution housing 48).

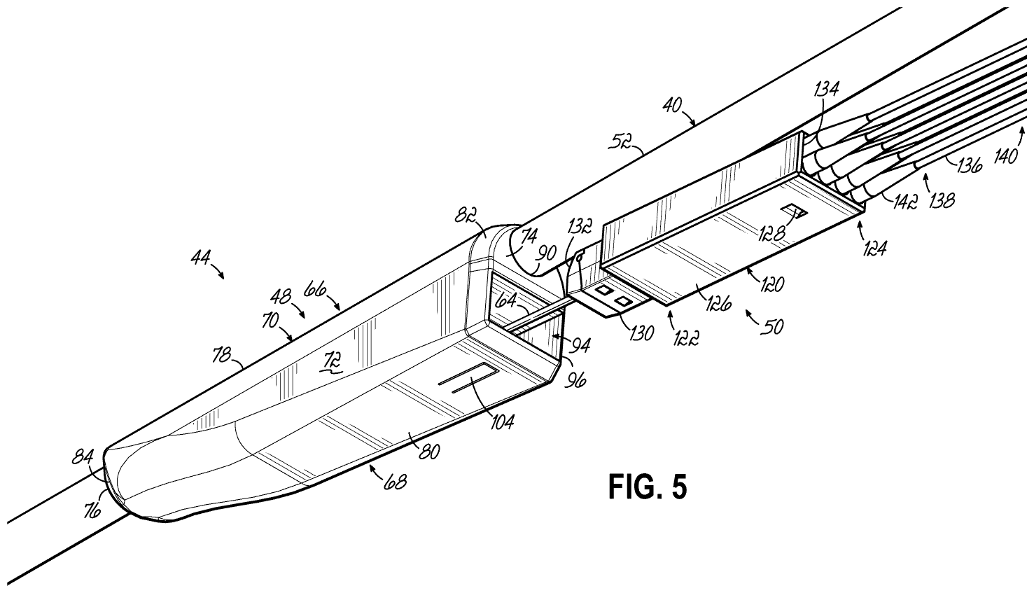

As best shown in FIGS. 6-8, the body 70 of the distribution housing 48 may include an internal opening 108 formed in the tubular inner sidewall 88 that places the passageway 86 of the cable receiving portion 66 in communication with the module bay 94. The opening 108 is located at or near the second end 102 of the module bay 94. In that regard, the base wall 98 of the module bay 94 may intersect the opening 108 and the tubular inner sidewall 88. As will be described in further detail below, the opening 108 allows the branch cable 64 to be routed from the fiber optic cable 40 and into the module bay 94 to be optically coupled to the splitter module 50. To that end, the base wall 98 of the module bay 94 may be notched to facilitate passage of the branch cable 64 through the opening and into the module bay 94. The notch in the base wall 98 may form part of the opening 108, for example. In either case, the module bay 94 is a passageway that extends generally between the opening 96 formed in the front end wall 74 of the distribution housing 48 to the opening 108 formed the tubular inner sidewall 88. To this end, the interior of the distribution housing 48 may be defined by the passageway 86 of the cable receiving portion 66 and the module bay 94 of the splitter receiving portion 68.

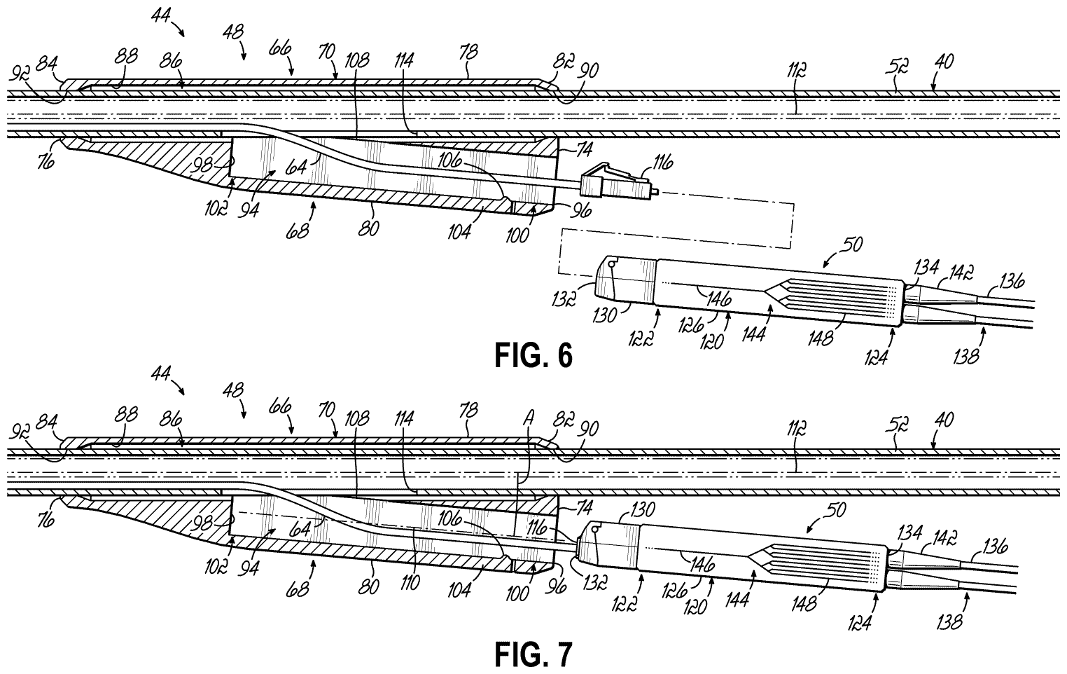

As shown in FIGS. 6 and 7, the module bay 94 may be generally angled relative to horizontal. In particular, the first end 100 of the module bay 94 may be spaced a greater distance, in a radially outboard direction, from the passageway 86 of the cable receiving portion 66 compared to the second end 102 of the module bay 94. As a result, a longitudinal axis 110 of the module bay 94 may be angled relative to a longitudinal axis 112 of the passageway of the cable receiving portion to form a module bay angle A, as shown in FIG. 7. The module bay angle A may be within a range of between 0° to 45°, and more particularly within a range of between 2° to 20°. In the embodiment shown, the module bay angle A is about 10°.

As briefly described above, each distribution housing 48 permits a subset of the plurality of optical fibers 42, such as a single optical fiber 42 in the form of a branch cable 64, to be routed from the fiber optic cable 40 and into the module bay 94 to be optically coupled to the splitter module 50. In that regard, the fiber optic cable 40 may include an opening or port 114 formed in the outer protective sheath 52 through which the branch cable 64 may be routed to exit the fiber optic cable 40. To this end, the number of optical fibers 42 that pass into the distribution housing 48 via the fiber optic cable 40 is greater than the number of optical fibers 42 that pass out of the distribution housing 48 via the fiber optic cable 40 by the number of optical fibers 42 that are terminated at the housing 48.

As shown in FIGS. 6-7, the port 114 in the fiber optic cable 40 may be configured to be aligned with the opening 108 between the passageway 86 and the module bay 94 so that the branch cable 64 may be routed from the fiber optic cable 40 and into the module bay 94 to be connected to the splitter module 50. In that regard, each branch cable 64 extends a length from the fiber optic cable 40 to a terminal end that is terminated with at least one branch connector 116. In the embodiment shown, there is only one branch connector 116 in the form of a single fiber connector, and specifically an LC connector, for forming an optical connection. However, it will be understood that there may be more than one branch connector 116 in alternative embodiments, and that regardless of whether there is one or several branch connectors, each branch connector 116 may be any simplex or duplex connector (e.g., LC or SC connectors) or any multi-fiber connector (e.g., MPO, SN-MT, or MMC connectors).

The distribution housing 48 may be formed from a rigid plastic material, such as rigid engineering plastics including polyethylene, acrylonitrile butadiene styrene, polypropylene, and other plastics. Other non-plastic materials may also be used. In one embodiment, the distribution housings 48 may be injection molded bodies (e.g., such as in two or more body portions) formed separately and then snap-fit together or otherwise connect together about the fiber optic cable 40 at the tap points 46. In an alternative embodiment, however, the distribution housings 48 may be over-molded onto the fiber optic cable 40 at the tap points 46. The molding processes are well understood and a further description will be omitted for sake of brevity. The above are exemplary methods for making the distribution housings 48 and it should be recognized that other methods may be used to form the housings 48 either separate from or directly on the fiber optic cable 40.

As briefly described above, the splitter module 50 may be selectively connectable to the distribution housing 48 and the branch connector 116 of the branch cable 64 to form an optical connection that splits the incoming optical signal of the branch cable 64 into multiple output signals. The multiple output signals may be associated with network equipment 18 in a rack 32 that is connected to the splitter module 50. With reference to FIGS. 5-8, the splitter module 50 includes a body 120 having a first end 122, an opposite second end 124, and an interior cavity 126. The body 120 of the splitter housing may be sized to be received within the module bay 94 and therefore is correspondingly rectangular in cross-sectional shape. As best shown in FIG. 5, the body 120 may include a recess or indent 128 formed in a base wall that is configured to receive the locking member 106 of the latch 104 of the distribution housing 48 to selectively attach the splitter module 50 to the distribution housing 48, as will be described in further detail below. Other types of locking members may be used in alternative embodiments to selectively attach the splitter module 50 to the distribution housing 48.

With continued reference to FIGS. 5-8, the first end 122 of the body 120 of the splitter module 50 may include an adapter 130 that forms a first adapter interface 132 of the splitter module 50. The adapter 130 may include at least one exterior port for selectively receiving the at least one branch connector 116 of the branch cable 64, as will be described in further detail below. The second end 124 of the body 120 of the splitter module 50 may include a second adapter interface 134 for receiving a plurality of tap cables 136. Each of the plurality of tap cables 136 may include a proximal end 138 and an opposite distal end 140. The proximal end 138 of each tap cable 136 may be terminated by a proximal tap connector 142 that is configured to be selectively connected to the second adapter interface 134 of the splitter module 50 to form an optical connection therebetween. The distal end 140 of each tap cable 136 is terminated by a distal tap connector (not shown) and is configured to be selectively connected to network equipment 18 in a rack 32 to form an optical connection therebetween.

As shown schematically in FIGS. 6 and 7, the splitter module 50 may include an optical splitter 144 that is positioned inside the interior cavity 126 of the body 120. The optical splitter 144 is configured to split the at least one incoming optical signal 146 received from the branch cable 64 into one or more outgoing optical signal(s) that are received by respective outgoing optical fiber(s) 148. In that regard, the proximal end 138 of each tap cable 136 is configured to be connected to a respective one of the outgoing optical fibers 148 at the second adapter interface 134 of the splitter module 50. For example, the second adapter interface 134 may include a plurality of ports each of which is configured to receive the proximal tap connector 142 of one tap cable 136. In some embodiments, the splitter module 50 may be formed such that the tap cables 136 and the body 120 of the splitter module 50 are an integral assembly, with the tap cables 136 extending through the second end 102 and into the body 120. The second adapter interface 134 and proximal tap connectors 142 are not needed in such embodiments. Instead, for example, tap cable optical fibers (not shown) may be fusion spliced to the outgoing optical fibers 148 within the body 120. Such an arrangement results in the tap cables 136 remaining with the body 120 rather than being selectively connectable thereto. In another embodiment, the tap cables 136 may be separately connectable to the body 120 of the splitter module 50 so that the amount of tap cables 136 connected to the second adapter interface 134 may be varied. For example, the second adapter interface 134 may have eight ports for receiving eight tap cables 136, but a specific application may only require six tap cables 136 to be connected to the second adapter interface 134, leaving two ports unused. To this end, the tap cables 136 may be pre-connectorized with appropriate connectors.

In the embodiment shown, the optical splitter 144 is a 1×8 optical splitter that is configured to split a single incoming optical signal carried by an input optical fiber 146 into eight outgoing optical signals received by respective outgoing optical fibers 148 of the splitter module 50. However, other optical splitter configurations are possible, such as a 1×4, 1×16, 1×32, or 1×64 optical splitter configuration, for example. The optical splitter 144 may be a planar lightwave circuit (PLC) optical splitter. However, it will be understood that alternative optical splitters may be used, such as a beam splitter cube, a star coupler optical splitter, or other suitable optical splitter capable of splitting optical signals into multiple output channels.

Having described certain details of the distribution assemblies 44 of the fiber optic cable assembly 38, the process of installing the splitter module 50 to the distribution housing 48 for one distribution assembly 44 will now be described. In that regard, to connect the splitter module 50 to the distribution housing 48, two connections are made, which can be described as an optical connection and a coupling connection. To make the optical connection, the branch cable 64 may be pulled out from the module bay 94 to expose the branch connector 116, as shown in FIG. 6. When so positioned, the branch connector 116 may be connected to the at least one exterior port of adapter 130 at the first adapter interface 132 of the splitter module 50 to form the optical connection, as shown in FIG. 7. The optical connection results in the incoming optical signal from the branch cable 64 being transmitted by the input optical fiber 146 and then split into outgoing optical signals transmitted by the outgoing optical fibers 148. The outgoing optical signals are then received by respective tap cables 136 connected to the splitter module 50, as described above.

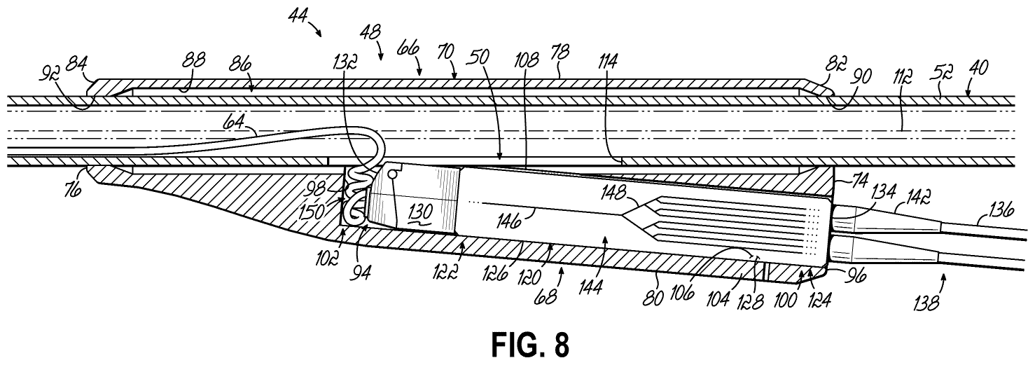

As shown in FIGS. 6 and 7, the splitter module 50 may be located external of the distribution housing 48 after the optical connection is made. In that regard, to couple the splitter module 50 to the distribution housing 48 (i.e., the coupling connection) the splitter module 50 is movable from a first position where the splitter module 50 is substantially located external of the module bay 94 (e.g., FIG. 7) to a second position where the splitter module 50 is substantially located within the module bay 94 (e.g., FIG. 8). In particular, once the optical connection is made, the splitter module 50 may be aligned with the module bay 94 and pressed into the module bay 94. In that regard, the splitter module 50 is slideably received into the module bay 94 until the indent 128 formed in the body 120 of the splitter module 50 is aligned over the latch 104 to receive the locking member 106 to thereby secure the splitter module 50 within the module bay 94. When so positioned, the optical splitter 144 of the splitter module 50 is arranged in the distribution housing 48. As shown in FIG. 8, when the splitter module 50 is fully received within the module bay 94, the branch cable 64 may be coiled or bunched in a space 150 between the first end 122 of the splitter module 50 and the base wall 98 of the module bay 94. To this end, the fiber optic cable 40, and more particularly the branch cable 64 may be a bend intensive fiber, such as an optical fiber that provides ITU-T G.657.A2 bend performance. One example of such an optical fiber is SMF-28 Contour Pro optical fiber commercially available from Corning Incorporated. The module bay 94 may be larger (i.e., longer) than the splitter module 50 to provide space for the branch cable 64 when the splitter module 50 is coupled to the distribution housing 48.

In an alternative embodiment, the branch connector 116 may remain within the module bay 94 such that the optical connection and the coupling connection are made substantially simultaneously by sliding the splitter module 50 into the module bay 94. Specifically, the branch connector 116 may be secured in place at the second end 102 of the module bay 94. For example, the branch connector 116 may extend from the base wall 98 of the module bay 94. As a result, a length of the branch cable 64 would be shorter compared to the length of the branch cable 64 shown in FIGS. 5-8. In this alternative embodiment, when the splitter module 50 is pressed into the module bay 94, the at least one exterior port of adapter 130 at the first adapter interface 132 of the splitter module 50 is pressed into engagement with the branch connector 116 to form the optical connection therebetween. At generally the same time, the body 120 of the splitter module 50 is aligned over the latch 104 to receive the locking member 106 to secure the splitter module 50 to the distribution housing 48. Thus, both the optical connection and coupling connection may be made by sliding the splitter module 50 into the module bay 94 to the fully seated position (i.e., the second position). In this same embodiment, the base 80 of the distribution housing may be hingeable, which allows for the base to be selectively opened to provide access to the branch connector 116 and module bay 94. In that regard, the base 80 may be opened about a hinge, such as a living hinge, that is located near the second end 102 of the module bay 94, for example, and the configuration may be similar to a clamshell hinge.

As mentioned above, the configuration of the distribution assemblies 44 provides the ability to vary the optical split count, or optical split ratio, at each tap point 46. By way of example and without limitation, the exemplary fiber optic distribution cable assembly 38 described above with respect to FIGS. 1-8 may include five distribution assemblies 44. Each distribution assembly 44 may be equipped with a splitter module 50 having a 1×8 optical splitter 144. Thus, it may be said that the optical split ratio for each optical splitter 144, and thus splitter module 50, is 1:8. To vary the optical split ratio at any or all of the distribution assemblies 44, the splitter module 50 may be removed and replaced with a different splitter module having an optical splitter with a different split ratio, such as a 1×4 (i.e., 1:4), 1×16 (i.e., 1:16), 1×32 (i.e., 1:32), or 1×64 (i.e., 1:64), for example. To swap out splitter modules 50, the installed, first splitter module 50 is removed from the distribution housing 48 by releasing the latch 104 and pulling the splitter module 50 from the module bay 94. In that regard, the splitter module 50 is moved from the second position where the splitter module 50 is substantially located within the module bay 94 (e.g., FIG. 8) to the first position where the splitter module 50 may be substantially located external of the module bay 94 (e.g., FIG. 7). Once removed from the module bay 94, the at least one branch connector 116 may be disconnected from the adapter 130 of the splitter module 50. The replacement splitter module having a different split ratio may then be connected to the at least one branch connector 116. The replacement splitter module may then be pressed into the module bay 94. To this end, the replacement module may be slideably received by the module bay 94 until the latch 104 engages the body of the replacement module to retain the replacement optical splitter in the distribution housing 48.

As briefly described above, the configuration of the distribution assemblies 44 provides the ability to vary the number of tap cables 136 at each tap point 46. By way of example and without limitation, the exemplary fiber optic distribution cable assembly 38 described above with respect to FIGS. 1-8 may include five distribution assemblies 44. Each distribution assembly 44 may be equipped with a splitter module 50 having a 1×8 optical splitter 144. In that regard, each splitter module 50 may be provided with eight tap cables 136 (i.e., a first set of tap cables), with each tap cable 136 being connected to a port corresponding to an outgoing optical fiber 148 at the second adapter interface 134 of the splitter module 50. However, the specific application may only require six tap cables 136. In that regard, the eight tap cables 136 may be disconnected from the splitter module 50 and only six tap cables reconnected (i.e., a second set of tap cables) to the splitter module 50. To this end, the splitter module 50 may provide the ability to change the number of tap cables 136 from a first configuration to a second configuration where the number of tap cables 136 in the first configuration is different (i.e., more or less) compared to the number of tap cables 136 in the second configuration.

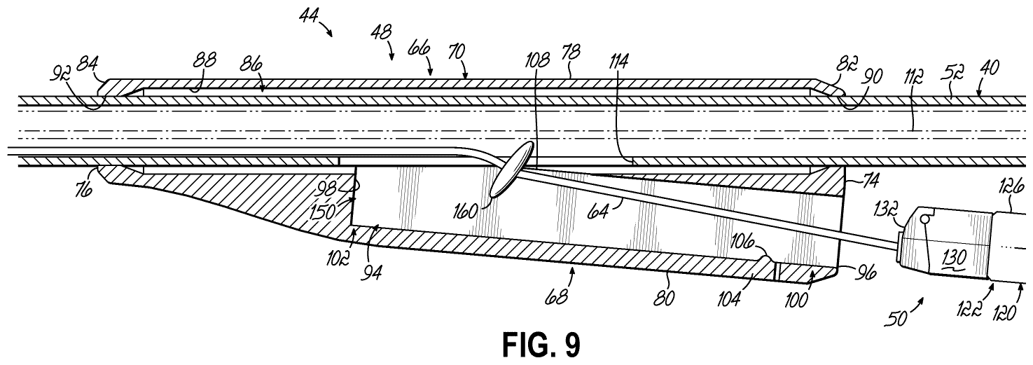

Referring now to FIG. 9, wherein like numerals represent like features compared to embodiments described above with respect to FIGS. 1-8, another embodiment of a distribution assembly 44 is shown and will now be described. The primary differences between the distribution assembly 44 of this embodiment and the distribution assembly 44 of the previously described embodiment includes use of a stop collar 160 on the branch cable 64 to prevent the branch cable 64 from being pulled too far out from the module bay 94, and possibly damaging the branch cable 64 and/or the fiber optic cable 40. As shown, the stop collar 160 may extend about the branch cable 64 at a location along the branch cable 64 that is proximate to the port 114 in the fiber optic cable 40 from which the branch cable 64 extends. In one embodiment, the stop collar 160 may be positioned between tubular inner wall 88 of the body 70 of the distribution housing 48 and the outer protective sheath 52 of the fiber optic cable 40. As shown in FIG. 9, when the branch cable 64 is pulled a maximum length from the module bay 94, the stop collar 160 is pulled into engagement with surfaces of the body 70 of the distribution housing 48 at the opening 108 to thereby limit the extent to which the branch cable 64 may be pulled from the module bay 94.

In accordance with another aspect of the invention, a method of making the distribution cable assembly 38 as described above will now be described. The method includes providing a fiber optic cable 40 carrying a plurality of optical fibers 44. Next, the distribution end 58 of the fiber optic cable 40 may be connectorized with a connector 62. A next step includes selecting tap points 46 along the length of the fiber optic cable 40 corresponding to the location of the racks 32 in a row 28 of the data hall 26 of the data center 10.

At each of the tap points 46, the method may include the following additional steps. First, branching at least one optical fiber 42 carried by the fiber optic cable 40 and terminating the at least one optical fiber 42 with at least one connector to define a branch cable 64 with a branch connector 116. Next, disposing a distribution housing 48 about the fiber optic cable 40 with the branch cable 64 being disposed in the module bay 94 of the distribution housing 48. As noted above, the distribution housing 48 may be injection molded parts that are assembled about the fiber optic cable 40 at the tap points 46. Alternatively, the distribution housing 48 may be formed by an over-molding process that includes a portion of the fiber optic cable 40. In a next step, the branch connector 116 may be connected to the exterior port of the adapter 130 that forms the first adapter interface 132 of the splitter module 50 to form the optical connection therebetween. The splitter module 50 may then be installed to the distribution housing 48 by sliding the splitter module 50 into the module bay 94 to secure the splitter module 50 to the distribution housing 48 (i.e., the attachment connection). This step may further include engaging the releasable latch 104 of the distribution housing 48 with the splitter module 50 to secure the splitter module 50 thereto. When so positioned, the optical splitter 144 of the splitter module 50 is arranged in the distribution housing 48. To this end, the splitter module 50 may be selected from a plurality of splitter modules having different optical split ratios as required for a specific application.

The method includes providing a plurality of tap cables 136 for connection to the splitter module 50. In that regard, each of the plurality of tap cables 136 may be terminated at a proximal end 138 and distal end 140 with a proximal connector 142 and a distal connector, respectively. In a next step, each tap cable 136 may be connected to an outgoing optical fibers 148 at the second adapter interface 134 of the splitter module 50. Specifically, the proximal connector 142 of each tap cable 136 may be inserted into a port at the second adapter interface 134 of the splitter module 50 to connect each tap cable 136 to a corresponding outgoing optical fiber 148 of the optical splitter 144.

As noted above, installation time and cost is a major consideration in data center construction. In use, the distribution cable assembly 38 described above provides improvements in these aspects over what is currently available. As pre-engineered solutions penetrate deeper into data center architecture (and fiber optic network architecture in general), it is expected that racks will be shipped from the manufacturing facility with pre-installed components and pre-installed cabling. In this way, the rack only needs to be placed along the desired row in the data hall of the data center, coupled to a suitable power source, and connected to the distribution cable corresponding to the row in which the rack is located. This latter aspect is where the distribution cable assembly 38 of the present disclosure may be particularly beneficial.

For example, prior to the arrival of a rack 32 for a selected row 28 in the data hall 26 of the data center 10, the distribution cable assembly 38 may be installed in the cable tray 36 corresponding to the selected row 28 such that the distribution housings 48 correspond to the anticipated location of the racks 32 that will fill out the row 28. The in-line and low-profile nature of the distribution housings 48 facilitates improved installation by eliminating or reducing snagging of the distribution cable assembly 38 during its routing along the cable tray 36. Once the distribution cable assembly 38 is installed, the rack 32 may be positioned in the selected row 28. Any unexpected setup changes to the network equipment 18 in the rack 32 may be accommodated by swapping the splitter module 50 at the impacted tap point 46 or changing out tap cables 136, for example. To this end, once the rack 32 is in position in the row 28, the tap cables 136 may be plugged into the network equipment 18 in the rack 32. It should be appreciated that additional racks 32 may be brought in and the process repeated until all of the racks 32 in the row 28 are positioned and connected to the intermediate distribution frame 34 via the distribution cable assembly 38. According to the above, the installation time, labor and costs for data center construction may be reduced, and the distribution cable assembly 38 as described above facilitates that improvement through not only improved installation (e.g., reduced snagging of the cable during the routing along the cable trays) but also improved scalability and plug and play capabilities.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Accordingly, departures may be made from such details without departing from the scope of the disclosure.

What is claimed is:

1. A fiber optic cable assembly, comprising:
a fiber optic cable having a distribution end, a terminal end, and carrying a plurality of optical fibers; and
a plurality of distribution assemblies attached to the fiber optic cable along a length of the fiber optic cable, wherein each of the plurality of distribution assemblies comprises:
a distribution housing receiving the fiber optic cable; and
an optical splitter disposed in the distribution housing,
wherein at each of the plurality of distribution housings:
a subset of the plurality of optical fibers carried by the fiber optic cable are branched off from the fiber optic cable and terminated by at least one branch connector, and
the optical splitter is configured to split an incoming optical signal from at least one optical fiber belonging to the subset of optical fibers into a plurality of outgoing optical signals carried by a plurality of outgoing optical fibers.

2. The fiber optic cable assembly of claim 1, wherein each of the plurality of distribution assemblies comprises:
a splitter module having a first end, a second end, and an interior cavity, the splitter module being selectively connected to the distribution housing,
wherein:
the splitter module includes the optical splitter in the interior cavity, and
the at least one branch connector is selectively connectable to the first end of the splitter module.

3. The fiber optic cable assembly of claim 2, wherein the distribution housing of each of the plurality of distribution assemblies includes a module bay configured to receive the splitter module, and wherein the splitter module is movable between a first position substantially located external of the module bay and a second position substantially located within the module bay.

4. The fiber optic cable assembly of claim 3, wherein the splitter module is slidable between the first position and the second position.

5. The fiber optic cable assembly of claim 2, wherein the splitter module and/or the distribution housing includes a latch for connecting the splitter module to the distribution housing.

6. The fiber optic cable assembly of claim 2, wherein the first end of the splitter module includes a first adapter interface having at last one exterior connector port for receiving the at least branch connector.

7. The fiber optic cable assembly of claim 2, further comprising a plurality of tap cables each having a proximal end and a distal end, wherein for each of the plurality of tap cables:
the proximal end is connected to or is configured to be connected to a respective one of the plurality of outgoing optical fibers of the optical splitter, and
the distal end is terminated by a distal tap connector.

8. The fiber optic cable assembly of claim 7, wherein the proximal end of each of the plurality of tap cables is terminated by a proximal tap connector.

9. The fiber optic cable assembly of claim 8, wherein the second end of the splitter module includes a second adapter interface having a plurality of exterior connector ports that is connected to or configured to be connected to a proximal tap connector of a respective one of the plurality of tap cables.

10. The fiber optic cable assembly of claim 1, wherein the at least one branch connector is a single fiber connector, and preferably a single fiber LC connector.

11. The fiber optic cable assembly of claim 1, wherein the distribution end of the fiber optic cable includes at least one multi-fiber connector, preferably one multi-fiber connector.

12. The fiber optic cable assembly of claim 1, further comprising a plurality of tap cables each having a proximal end and a distal end, wherein for each of the plurality of tap cables:
the proximal end is connected to or is configured to be connected to a respective one of the plurality of outgoing optical fibers of the optical splitter,
the distal end is terminated by a distal tap connector, and
the proximal end of each of the plurality of tap cables is terminated by a proximal tap connector.

13. A method of handling a fiber optic cable assembly, comprising:
a fiber optic cable having a distribution end, a terminal end, and carrying a plurality of optical fibers; and
a plurality of distribution assemblies attached to the fiber optic cable along a length of the fiber optic cable,
wherein each of the plurality of distribution assemblies comprises:
a distribution housing receiving the fiber optic cable; and
an optical splitter disposed in the distribution housing,
wherein for each of the plurality of distribution housings:
a subset of the plurality of optical fibers carried by the fiber optic cable are branched off from the fiber optic cable and terminated by at least one branch connector, and
the optical splitter is configured to split an incoming optical signal from at least one optical fiber belonging to the subset of optical fibers into a plurality of outgoing optical signals carried by a plurality of outgoing optical fibers,
the method comprising for at least one of the plurality of distribution assemblies:
removing the optical splitter from the distribution housing, the optical splitter having a first split ratio;
disconnecting the at least one branch connector from the optical splitter;
providing another optical splitter having a second split ratio different from the first split ratio;
connecting the at least one branch connector to the another optical splitter; and
attaching the another optical splitter to the distribution housing.

14. The method of claim 13, wherein the optical splitter is provided in a first splitter module and the another optical splitter is provided in a second splitter module, and wherein:
removing the optical splitter from the distribution housing includes removing the first splitter module from the distribution housing; and
attaching the another optical splitter to the distribution housing includes attaching the second splitter module from the distribution housing.

15. The method of claim 14, wherein:
disconnecting the at least one branch connector from the optical splitter includes disconnecting the at least one branch connector from the first splitter module; and
connecting the at least one branch connector to the another optical splitter includes connecting the at least one branch connector to the second splitter module.

16. The method of claim 14, wherein the distribution housing includes a module bay for receiving a splitter module, and wherein:
removing the first splitter module from the distribution housing includes slidably removing the first splitter module from the module bay; and
attaching the second splitter module to the distribution housing includes slidably inserting the second splitter module into the module bay.

17. The method of claim 14, wherein:
removing the first splitter module from the distribution housing includes releasing a latch to allow the first splitter module to be removed from the distribution housing; and
attaching the another optical splitter to the distribution housing includes engaging a latch to allow the second splitter module to be retained in the distribution housing.

18. The method of claim 13, further comprising:
disconnecting a first set of the plurality of tap cables from the first optical splitter; and
reconnecting a second set of the plurality of tap cables to the second optical splitter,
wherein the number of tap cables in the first set of the plurality of tap cables is different from the number of tap cables in the second set of the plurality of tap cables.

19. A method of making a fiber optic cable assembly, comprising:
providing a fiber optic cable having a distribution end, a terminal end, and carrying a plurality of optical fibers;
selecting a plurality of distribution locations along a length of the fiber optic cable;
wherein at each of the plurality of distribution locations, the method further comprises:
branching off a subset of the plurality of optical fibers carried by the fiber optic cable;
terminating the subset of the plurality of optical fibers with at least one branch connector;
disposing a distribution housing about the fiber optic cable; and
locating an optical splitter in the distribution housing, wherein the optical splitter is configured to split an incoming optical signal from at least one optical fiber belonging to the subset of optical fibers into a plurality of outgoing optical signals carried by a plurality of outgoing optical fibers; and
connecting the at least one branch cable to the optical splitter.

20. The method of claim 19, wherein the optical splitter is provided in a splitter module, wherein locating the optical splitter in the distribution housing includes locating the splitter module in the distribution housing, and wherein the splitter module is selected from a plurality of splitter modules, each of the plurality of splitter modules having a different optical split ratio.
